(19) United States
(12) Patent Application Publication
(10) Pub. No.: US 2005/0137954 A1
(43) Pub. Date: Jun. 23, 2005

(54) Reduced-risk income producing equity method

(76) Inventor: Robert L. Alldredge, Denver, CO (US)

Correspondence Address: RICK MARTIN;PATENT LAW OFFICES OF RICK MARTIN, PC, 416 COFFMAN STREET, LONGMONT, CO, 80501, US

(21) Appl. No.: 10/742,475

(22) Filed: Dec. 19, 2003

(51) Int. Cl. G06F 17/60

(52) U.S. Cl. 705/36

(57) ABSTRACT

A reduced risk income producing property methodology that allows ownership in property shares by an owner-promoter, by a lessee(s) and lender(s). Risk is reduced by providing a lower risk to all parties and allowing ownership while also allowing reinvestment of profits back into the equity of the property with an additional option of excess profits made available to begin an additional building construction.

### FIELD OF THE INVENTION

The present invention relates to a business method wherein an assembly of procedures will reduce the risk in the investing in income-producing and/or equity-producing property. It provides a solution for all major parties to be owners-investors in such property.

### BACKGROUND OF THE INVENTION

Investing in an income-producing or equity-producing company or property involves major cash investment and usually an associated risk in losing that investment. The investment comes with risks to all parties involved. The organizer, promoter, and the investor have the risk of not producing a favorable return on investment. The present invention is applicable to income-producing companies that create a product. Typical such products are energy, electricity, fuel, machinery, equipment, chemicals, plastics, raw materials, processed materials, and unprocessed materials. Where the property is a building, the lessee has the risk of not being able to easily expand (or reduce) area depending on dynamic business requirement changes. If the lessee's business declines the lessee may not be able to pay the monthly rental. The lessee may be motivated not to pay the monthly rental and the lessee may be forced out of business. If the lessee's business declines, one option is to move to another location where less square footage is leased. If the lessee's business increases, the lessee may also be forced to move to another location with more square footage. All of these dynamic variables can affect the initial risk of an income-producing facility. The lender(s) may demand a rate of interest so high that the owners must invest an excessive amount of the total cost to keep the building-ownership company solvent. The owners have the risk that the economy may change such that the lessee may cease business and that the lender may foreclose on the mortgage. On the other hand, the owner may also have the risk that the lessee's business expands and that the facility may not be expandable. This can lead to non-renewal of the lease, search of new tenants, missing of mortgage payments and potential foreclosure.

Yet another factor is that the gift taxes and inheritance taxes are prohibitive. Those taxes inhibit a person from transferring wealth to that person's heirs as an inheritance or to others as a gift.

What is needed is a methodology to quickly reduce the risk to all parties involved. What is also needed is a methodology that allows ownership by all parties in the income or equity producing property. The present invention solves these and many other problems. The present invention utilizes a set of procedures to reduce the risk, allow ownership by all parties and reinvest a portion of the profits of the facility back into the equity of the facility. It also utilizes a facility design for easy expandability.

### SUMMARY OF THE INVENTION

The main aspect of the present invention is to provide a business structure such that income-producing property is leased and that at least some of the lessees can be given the option to buy shares in the LLC (Limited Liability Company), and to buy shares in an accompanying Shareholders Participation Note (SPN).

Another aspect of the present invention is to provide a business structure such that at least some of the lenders can be given the option to buy shares in the LLC and to buy shares in the accompanying SPN.

Another aspect of the present invention is to provide a simple-interest loan that can have its interest payment delayed for a period of time without foreclosure.

Another aspect of the present invention is to provide such that the period of time, starting from the date on which the interest payments were previously made, would bring the interest payments up to date at the start of the present time.

Another aspect of the present invention is that some of the money invested in the business structure is lent to the business structure on a recorded note.

Another aspect of the present invention is that some of the monies made from the purchase of shares may be applied first to the outstanding principle of the loan and/or loans.

Another aspect of the present invention is that a portion of the profits may be retained and applied to the payment of the outstanding principle until the principle is reduced to a fixed amount. For example, the fixed amount may be from zero to twenty percent of the original amount.

Another aspect of the present invention is to reduce the cost of additional construction by utilizing buildings that are similar in some features, or that are essentially identical.

Another aspect of the present invention is to provide a means for the LLC to purchase shares for an amount that is relative to the total investment of the shares in the case of any party withdrawing ownership for any reason that might occur.

Another aspect of the present invention is to provide a means for the LLC to sell available shares to an acceptable shareholder for the amount originally assigned to the share value or for the amount invested in the share.

Another aspect of the present invention is to provide a means that a lessee(s) may receive an option to procure shares in a quantity that is a ratio of the space leased and provided over the years of the lease.

Another aspect of the present invention is to provide a means that allows for additional principle payments to be somewhat the same as the annual depreciation allowed by the IRS (Internal Revenue Service).

Another aspect of the present invention is to provide a means that would allow the LLC to procure a shareholder(s) shares and a shareholder's accompanying share of the SPN for the amount of money that the shareholder has invested in the LLC should the shareholder(s) or partners withdraw by demand, death, divorce or threat of divorce or any other reason.

Another aspect of the present invention is to provide that a means of payment to the shareholder of any early withdrawal be via a no-interest note for some period of time and due on some future date (two to three years, for example).

Another aspect of the present invention is to provide a means such that the LLC manager is required to find a buyer, for early withdrawal shares and for early-withdrawal SPN shares, who will pay for the shares the amount owed to the withdrawing shareholder.

Another aspect of the present invention is to provide a means to authorize the LLC manager to sell the early withdrawal shares to heirs and/or designated parties at the same amount as was paid for the shares in response to the threat and/or act of early withdrawal.

Another aspect of the present invention is to provide a means such that the lender is provided an option to procure shares.

Another aspect of the present invention is to provide a means such that the base lease amount is first applied to pay interest on the loan(s) and then applied to pay the principle of the loans at the rate of depreciation allowed by taxing authorities, and finally any remaining monies to be distributed to all shareholders as profits.

Other aspects of this invention will appear from the following description and appended claims, reference being made to the accompanying drawings forming a part of this specification wherein like reference characters designate corresponding parts in the several views.

It should be noted that the following description of the present invention is not limited to the titles or selections discussed.

The present invention provides a method and procedures for the organizer-promoter-investor to be in partnership with moneylenders and lessees with respect to an income-producing or equity-producing property. The present invention thus creates a “Reduced-Risk Income Producing Property” or RRIPP. The present invention applies to any entity that is an income-producing property investment which includes, but is not limited to, commercial/industrial property, agricultural property, apartments, housing, research/development facilities, yachts, power generating wind farms, etc.

This invention is applicable also to companies that create a service, or structure that produces an income. A typical such company is a company that leases property such as buildings and/or land. To describe and explain the invention, the features of the invention are revealed as they apply to the leasing of income-producing property, such as industrial and factory building.

### BRIEF DESCRIPTION OF THE DRAWINGS

FIGS. 1A through 1H show forecasted financial cash flow and balance sheets over an eight year period for a property based LLC

FIG. 2 is a flow chart of the process of the present invention.

FIG. 3 is an example of a LLC facility with future expansions.

FIG. 4 is an example of a LLC facility showing the variable space available within a building.

FIG. 5 is an illustrative drawing of a simple LLC start up showing the first year of cash flow.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE INVENTION

The present invention provides a business structure and methodology for an income producing property, including providing a Limited Liability Company (LLC) in which both lessees and lenders are given an option to buy shares in the LLC. The methodology would provide for simple interest loans that have the ability to have an interest payment delayed for a period of time, if required, and then brought back up to date.

In the LLC methodology all monies from share purchases are applied first to the outstanding principal of the outstanding loan as are a portion of the profits. The payment of profits against principal continues until the principal is reduced to a predetermined fixed amount. For example, zero to twenty percent of the original amount.

The lessee(s) will receive an option to procure shares in a quantity that is a ratio of the space leased and provided over the years of the lease.

The present invention provides for the LLC to purchase shares for an amount that is relative to the total investment of the shares in the case of any party withdrawing ownership for any reason that might occur. The LLC can also sell available shares to an acceptable shareholder for the amount invested in or originally assigned to the share value. The LLC will procure a shareholder(s) shares for the amount of money that the shareholder has invested in the LLC should the shareholder(s) or partners withdraw by demand, death, divorce or threat of divorce or any other reason prior to the termination of the lease agreement. Thus, a means of payment to the shareholder of any early withdrawal will be issued via a no-interest note for some period of time and due on some future date (two to three years, for example). The LLC manager is required to find a buyer for early withdrawal shares who will pay for the shares the amount owed to the withdrawing shareholder. The LLC manager is authorized by operating agreements to sell the early withdrawal shares to heirs and/or designated parties at the same amount as was paid for the shares in response to the threat and/or act of early withdrawal.

A lender is provided an option to procure shares (SP shares) if the lender is providing a lower than normal interest rate via LP notes. LP notes will also be paid down with additional principle payments somewhat the same as the annual depreciation allowed by the IRS (Internal Revenue Service).

The base lease income is first applied to pay interest on the loan(s) that are not covered by the Participation Note, and then on the interest on the Lender Participation Note and Shareholder Participation Note. A percentage (50% for example) of excess profits are then applied to pay the principle of the loans along with depreciation allowed by taxing authorities, and finally any remaining monies are distributed to all shareholders as profits.

Although this invention is not limited to them, the examples given below are related to an entity consisting of property with building floor space that is leased.

The ability to save on future construction for LLC expansion is realized by utilizing essentially identical future buildings or buildings with very similar features.

There are various factors that one must consider in building a commercial property to optimize the income producing ability of such property. One such factor is location. If a small business is to be successful the location should have easy access to interstate highways, airports, railroad commercial terminals and employee drive-to-work routes. The ability to easily lease a facility and to obtain a good lease rate depends greatly on the location.

Another factor is the facility itself. A well-designed facility should have the following:
a) Adequate space.
b) Attractive and well maintained grounds.
c) Construction that is well engineered for services.
d) Efficient heating, lighting and air-conditioning.
e) Sufficient truck docking with levelers and drive-in 14 ft doors on the entire building.
f) Sufficient power in the electrical system to service the lessee(s) and have ample room for expandability.
g) Sufficient interior ceiling height (20 feet or greater below construction beams).
h) Ample facilities for employees such as parking, restrooms, lighting, eating, etc.
i) Ability to expand with lessee's needs.

Once a facility is adequately constructed and located, the lease of the facility will become less of a risk.

The present invention will allow means of a lessee to lease square footage for a specific amount plus NNN (triple-Net), as do most leases. The major difference to the lessee is that the lessee (as well as the lender and promoter) will be provided with an option to buy a fraction of the shares. This option will be in a quantity that is a ratio of the space leased and provided over the terms of the lease. This option to procure shares will be at interest delayed until the building(s) is fully leased and fully occupied, and at an interest rate much lower than a construction loan.

Shares can be optioned to:
a) The lessee in the form of shareholder participation shares.
b) The owner-promoter in the form of shareholder participation shares.
c) The lender (in return for a lower interest rate) in the form of lender participation (LP) notes (or shares).
d) Other parties deemed appropriate by the owner-promoter. For example, the lenders could also be issued shareholder participation (SP) shares.

The lessee's options can be given to others, or assigned, or sold as the lessee may designate within the structure established by the LLC.

Establishing a stable financial environment, which is enhanced by the degree to which the original loan is repaid, reduces the investment risk to all parties. The original bank loan is converted to LP notes and to SP shares as soon as offerings are provided. The reduction of the original loan is accelerated by investment of profits of some or all of the shareholders by the requirement that they invest a stated fraction (70% for example) of their profits into the LLC. The LLC, in turn, is required to invest the profit back into the remaining unpaid principle of the loan. This procedure would continue until the remaining unpaid portion of the loan is down to a pre-determined fraction (30% for example) of the original cost of the building and land. The fraction might also be considered to be some relationship to the annual IRS-permitted depreciation and the annual principle payment on the loan. This procedure enhances the loan payoff at an accelerated rate, providing less risk and a much more stable financial environment. A normal 30-year loan can be paid off in less than half of the time. At the point in time where the loan is down to the stated fraction percentage, the yearly profits would dramatically increase for each year remaining, as the loan payoff would revert to normal payments in lieu of applying excess profits to the principal. Yearly expenses include principal, interest, taxes, insurance (PITI) along with utilities, property maintenance, etc.

If a lender can be found who would also procure a vested interest via buying shares and would also offer a loan at a lower rate, more yearly profits could be realized along with a faster payoff period.

Excess yearly profits could also be placed as a down payment to finance another building to expand the total concept to more than one facility by continued financing of new buildings.

Constructing two or more facilities with buildings that are essentially identical or very similar in design, construction, materials, or repeating modules can significantly reduce the cost of construction of the buildings. If the LLC acts as the prime contractor on subsequent buildings, the cost can again be reduced. Reduced costs support better financial stability to the owner, lender and lessee in share ownership.

Protection must be offered to the LLC integrity when demands by shareholders to withdraw their investment or to sell their shares arise. At the death/divorce of a shareholder, the IRS can place a high value on shares held. This high share value could potentially force the sale of property and/or liquidation of the LLC. This can also destroy, by taxation, the estate of the shareholder. To solve this problem (at death, divorce, threat of divorce, bankruptcy, or threat of bankruptcy, demand for withdrawal, etc.) the shares are purchased from the shareholder or from the shareholder's estate at the total price of that shareholder's investment, and paid by a no-interest note. During the term of the note, shares are sold to an acceptable shareholder for the same amount. The LLC manages the transactions. The total investment is calculated as the sum of the purchase price of the shares, the amount of the shareholder profits that is retained, and that share of the profits that is applied to pay off the loan.

Another benefit to the lessee as a shareholder can be that the rental remains constant or increases at a stated rate over the period of lessee ownership or, over a specific period of a lease.

Although the examples herein are given to show the LLC ‘income-producing property’ as a building type facility (manufacturing, development, medical, etc), it should be noted that the ‘income-producing property’ can be other than a building facility as described and can also pertain to other ‘property’ such as charter yachts, condo's, agriculture, power generating wind farms, commercial/industrial sites, and the like.

The following Table I is presented herein to illustrate a comparison of the present invention to U.S. Pat. No. 6,292,788B1 issued Sep. 18, 2001 to Roberts et. al. This prior art patent relates to methods and investment instruments for performing tax-deferred real estate transactions comprising aggregating real property to form a real estate portfolio, encumbering the property with a master agreement and creating a plurality of deedshares by dividing title in the real estate portfolio into a plurality of tenant-in-common deeds of at least one predetermined denomination, each subject to a provision in the master agreement for re-aggregating the plurality of tenant-in-common deeds after a specified interval. The comparison chart (Table I below) is presented to show the differences with the present invention. This prior art patent differs from the present invention in its structure and other areas as shown below.

TABLE I
(Comparison to prior art patent)

| Present Invention | U.S. Pat. No. 6,292,788B1 |
|---|---|
| All tenants are | Master tenant - uses deed shares but |
| owner/investors | actual tenant is not necessarily a |
| | deedshare holder |
| Money Lenders are | No such provision - property money is |
| investors via lower | up front by deedshare holders |
| rates | |
| Monies applied first to | Master tenant signs up for pre- |
| outstanding principle | determined lease to deedshare holders |
| of loan and interest | |
| A portion of the | Deedshare holder gets steady money |
| profits are retained | stream based on master agreement but |
| and applied to the | property is paid for up front - |
| outstanding principle | deedshare holder puts in money as in |
| until it is reduced to | buying a bond |
| a fixed amount | |
| Future construction | Just a portfolio of properties |
| cost can be reduced by | |
| replication | |
| LLC can purchase shares | Deedshare holder can exchange |
| from withdrawing party | deedshare |
| Lessee can purchase | No such provision |
| shares via ratio of | |
| leased space | |
| Additional principle | Depreciation is handed back to |
| payments based on | deedshare holders as a tax benefit |
| yearly depreciation | |
| allowed by IRS | |
| LLC promoter is a | Managed by master tenant |
| shareholder | |
| LLC promoter is a | Master tenant is property manager BUT |
| property manager | can sublease (at a profit) any |
| | property in portfolio |
| Steady income | Master tenant is property manager BUT |
| | can sublease (at a profit) any |
| | property in portfolio |
| | Tax deferred benefits |
| | Deedshare holders sell their |
| | deedshares to master tenant at end of |
| | master lease interval which reaggravates |
| | title under master tenant |
| | at fair market value. Master tenant |
| | must buy if deedshare holder demands |
| | Master agreement controls provisions |
| | such as master tenant maintaining, |
| | insuring, pays taxes |
| | Allows deedshare exchange tax |
| | deferred |
| Share money used | Share money equals total purchase |
| towards a down payment | price |
| on property | |

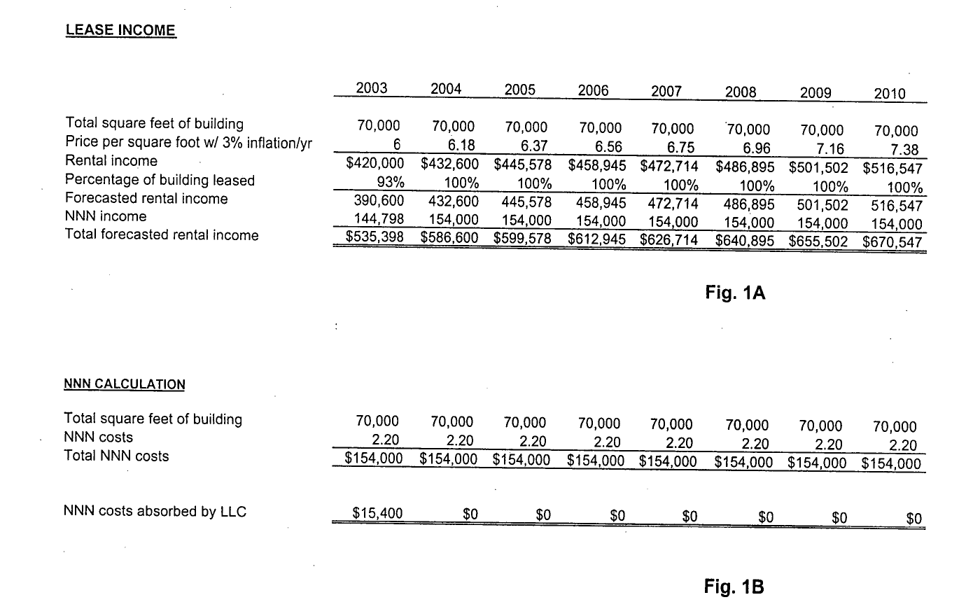

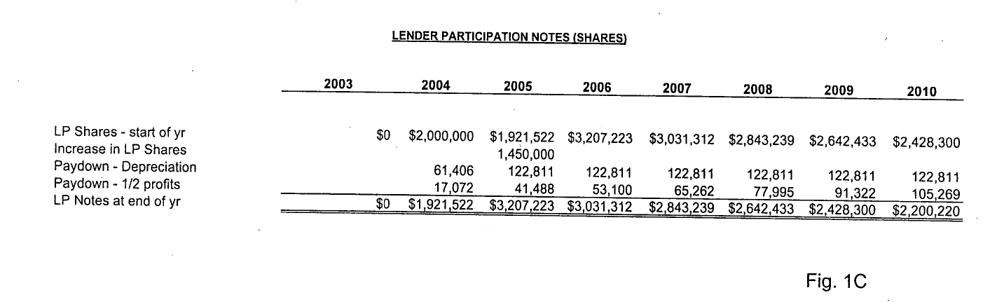

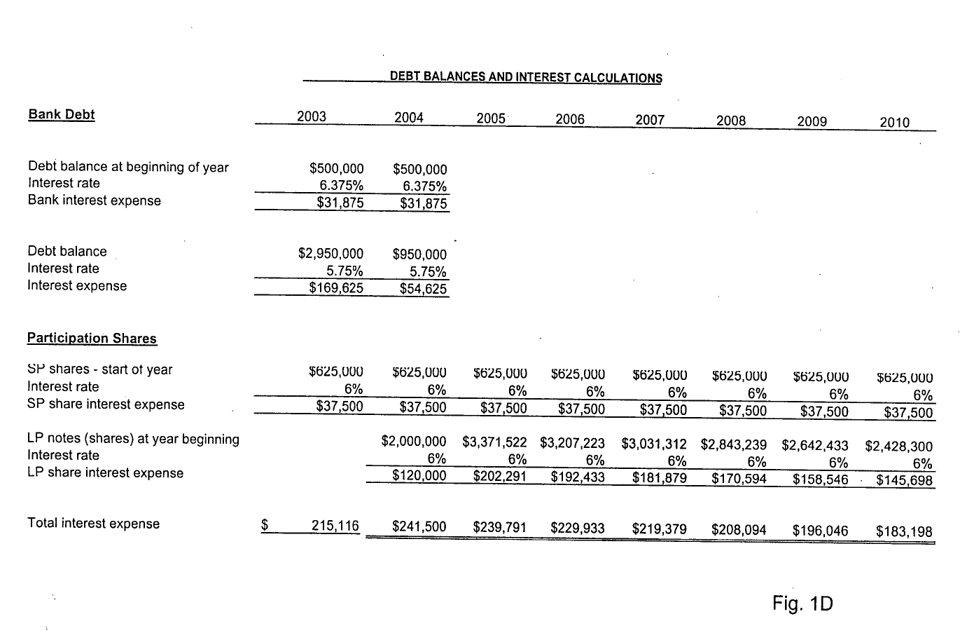

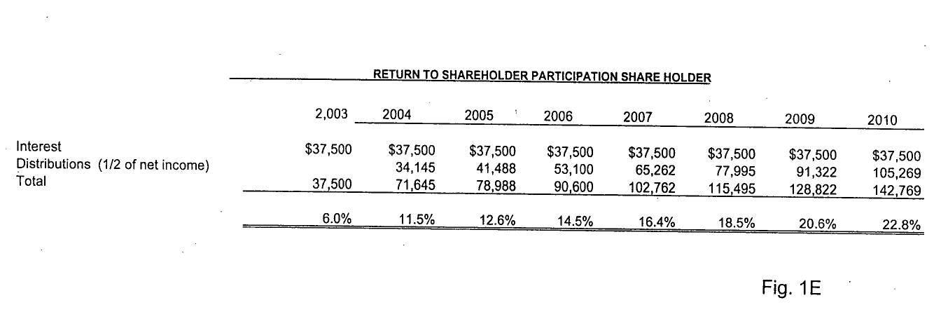

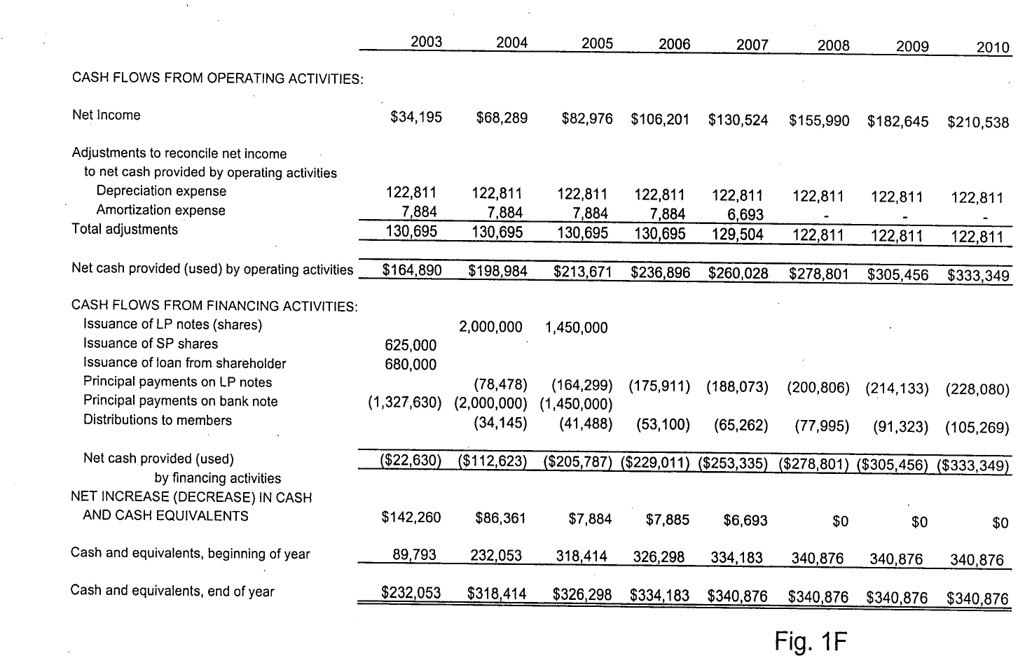

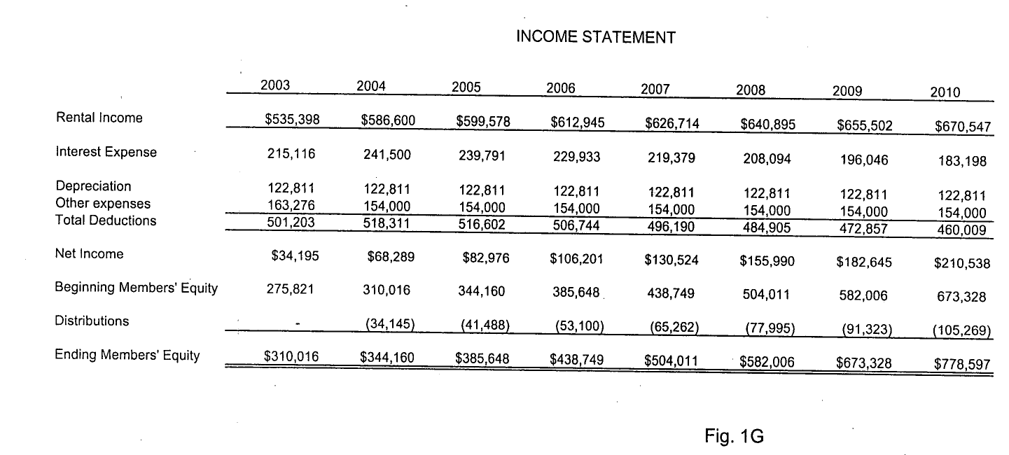

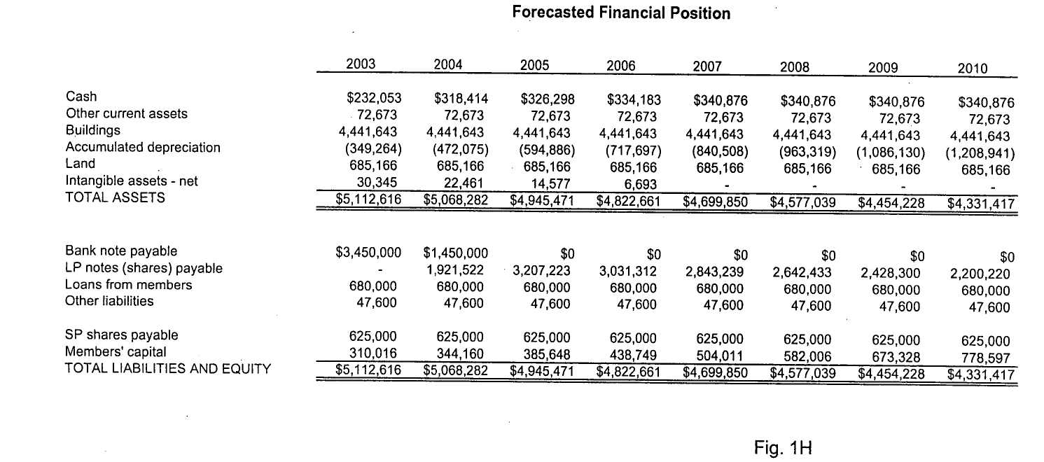

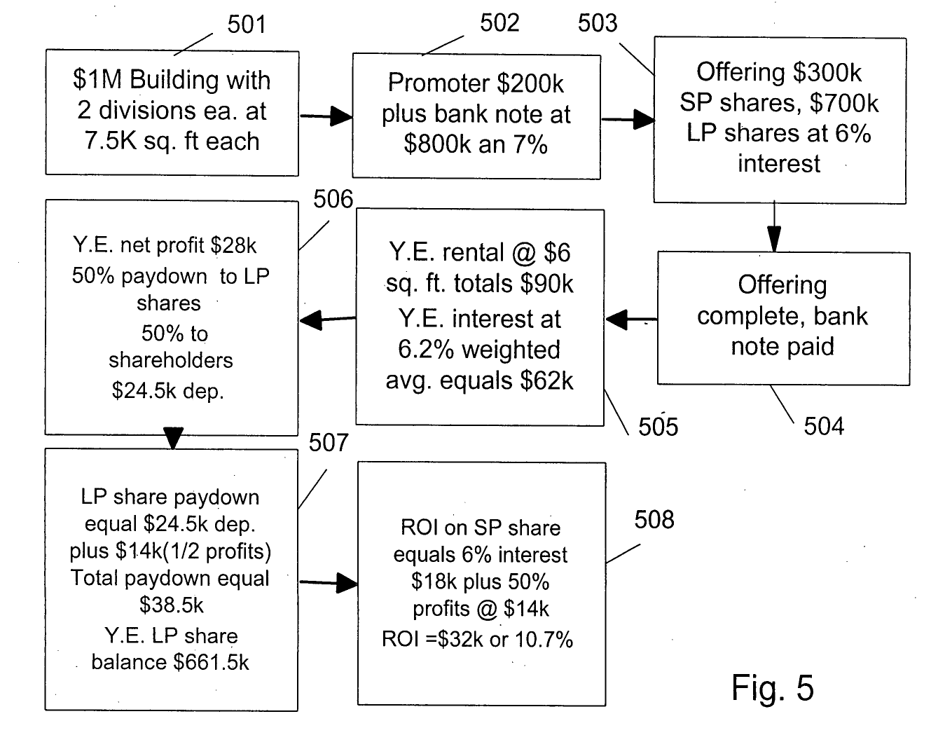

Continuing onto the figures contained herein, for purposes of illustration, two examples are demonstrated with respect to the present invention. FIGS. 1A thru 1H illustrate a detailed example of cash flow over eight years. A simple cash flow example is shown in FIG. 5.

The following example shows cash flow and balance sheets for an assumed corporation titled F.S. Properties with forecasts over a period of years from 2003 to 2010. Details of this example are illustrated in FIGS. 1A thru 1H. It is assumed in the following scenario the following:
a) 70,000 sq. ft. of leased space with a 93% occupancy in the first year (2003) and 100% occupancy thereafter.
b) Lease income starting at $6 per square foot and increasing by 3% per year.
c) NNN fees at $2.2 per square foot, constant.
d) $3,450,000 of debt at 2003 is still with the Bank, and the remaining debt is shareholder loan to the promoter at 0% interest.
e) Shareholder participation (SP) shares are held in the amount of $625,000 starting at Dec. 31, 2003 and these shares pay 6% interest. The balance is not paid down but rather the net income is distributed to these annually. These are essentially owners in the LLC.
f) Lender participation (LP) notes (shares) are issued starting in 2004 and bear a 6% interest paid annually as cash flows permit. These notes are paid down by an amount equal to the current years depreciation and 50% of the profits.
g) Prepaid expenses and intangible assets are assumed to remain constant throughout the forecast period.
h) Land, buildings, and furniture are carried at cost.
i) Interest is calculated based on beginning of the year debt balances; debt pay down is assumed to be on the last day of the year.
j) In the year 2003 all shares are-not issued, thus the total interest shown is a forecasted result of weighted average interest on loans, shareholder and lender shares. Shares are also issued in the year 2004, thus interest shown is a weighted forecast.
k) Income taxes—since limited liability companies have the tax attributes of a partnership, the entity does not incur federal and state income taxes, instead, its taxable income and losses are included in the tax returns of its members and taxed depending on their tax situations.
l) All debt is converted to LP notes (shares) beginning in the year 2005.

Continuing on to described the drawings contained herein, FIG. 1A shows A.B.C. Properties Lease Income projections for the years 2003 through 2010. It should be noted that the financial numbers presented are forecasted numbers and that the years 2003 and 2004 are assumed as start-up years. The financial example is presented below by way of example and illustration but should not be considered to limit the invention to this particular embodiment. Numbers depicted are presented as an example only for purposes of explaining a possible working example of the present invention.

From FIG. 1A, rental price per square foot is assumed to start at $6 per square foot per year, increasing at 3% per year. NNN is assumed constant at $2.20 per square foot. A 93% occupancy is shown for year 2003. Forecasted rental incomes are shown for each year and NNN is added to show total projected income. FIG. 1B depicts the NNN per year for the eight year period, which is also carried up to FIG. 1A under NNN income. The LLC is assumed to absorb the extra NNN costs in the first year due to a lower occupancy rate.

FIG. 1C depicts forecasted LP notes (shares). The forecast assumes no outstanding shares in year 2003, $2M in 2004 and $3.37M in 2005. Prior to 2005 all, or a portion thereof, are held via bank notes in lieu of LP shares. Also shown are the yearly pay downs of the LP shares, assumed to consist of depreciation and 50% of the profits. In the year 2004 it is assumed to apply only 50% of the profit and depreciation, as lender participation shares are not totally distributed.

FIG. 1D depicts debt balances and interest calculations from bank debt and participation shares, including both shareholder and lender participation notes (shares). It can be seen that LP shares accrue interest and that balances are decreasing each year (as shown in FIG. 1C) due to the depreciation and 50% profit pay down. It is also noted that SP shares remain at a constant value with a fixed interest rate of 6%. Total interest is shown for each year.

FIG. 1E depicts the forecasted return on investment (ROI) to shareholder participation shares. It can be seen that the ROI is 11.5% in 2004 and steadily grows to 22.8% in 2010. Thus the forecasted ROI is very profitable on an initial investment. In the year 2003, the return to shareholder is assumed with zero distributions, thus only the 6% on any outstanding SP shares. For simplicity, it is assumed that there is $625 k of SP shares.

FIG. 1F is a shows forecasted cash flows for the period of years 2003 through 2010. Each year-end cash equivalents and increases are shown on the last row.

FIG. 1G depicts the annual income statement showing income from rental, total deductions from interest, depreciation and other expenses, thus providing the net income. It also shows the beginning year members equity and distributions per year showing the equity increase each year.

FIG. 1H is the forecasted financial position of the LLC overall asset and liability balance sheet for each year. The balance sheet shows the total assets and the total liabilities. It should be noted that members capital continues to accrue while members participation shares remain at a constant value. Land and buildings are assumed to remain at a constant value throughout the period, as is the value of other current assets.

It can be seen from the above example that the LLC methodology of the present invention results in significant dollar advantages to the shareholders in the period that is depicted.

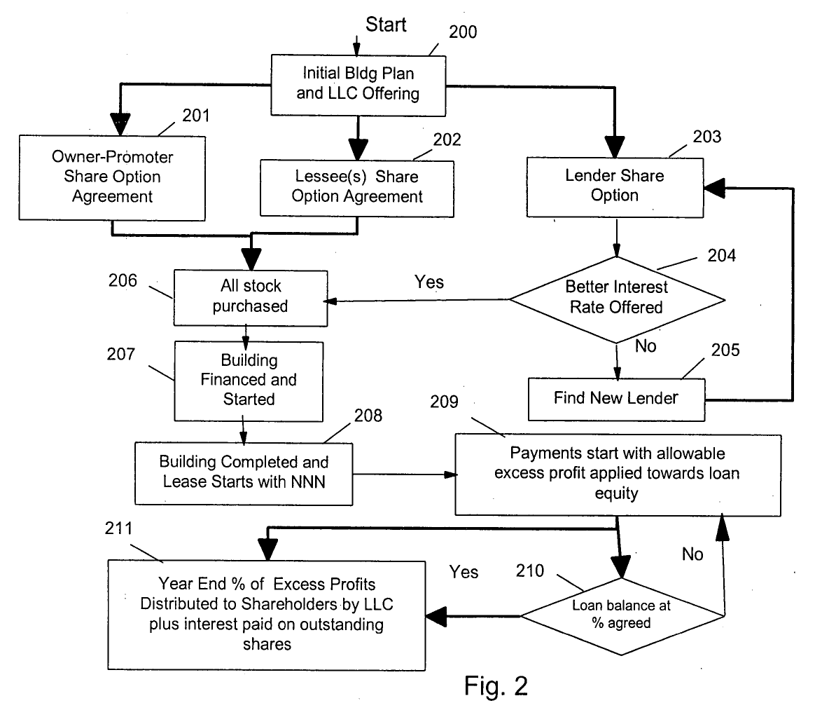

FIG. 2 is a flow chart of the LLC process of the present invention. The process starts with an initial building plan and offering by the LLC 200. An owner-promoter share option agreement is established 201, a lessee(s) is found and a lessee(s) share option(s) agreement is established 202, and a lender share option is offered 203. A lender is asked to agree to a better than commercially available interest rate 204. If the lender does not agree to a better interest rate offering, a new lender is sought 205. If a lender agrees to a better share offering 204 and the lender share option 203, all stock purchases are completed 206. The building is then financed and construction started 207. Upon completion the lease(s) start 208 and the lessee(s) pay the NNN. Monthly mortgage payments commence with the allowable excess monthly profit applied towards the loan equity 209. Each month it is determined if the loan balance is at the percentage agreed to 210. If the balance is not at the percentage agreed to, payments continue with allowable excess profit applied towards the loan equity 209 and any year-end profits are distributed to shareholders along with interest paid on all outstanding participation shares 211. Once the loan balance reaches the agreed to percentage, then the addition excess profits will be applied to the shareholders 211 at year's end. As previously discussed, excess profits may also be useable to begin a new construction if agree upon by all parties.

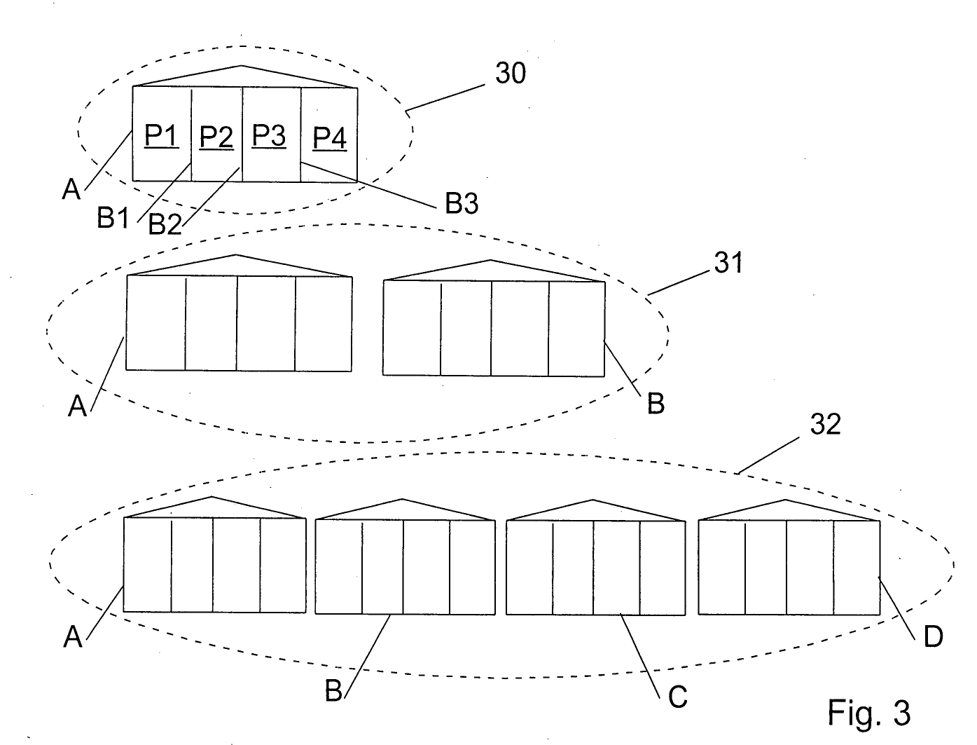

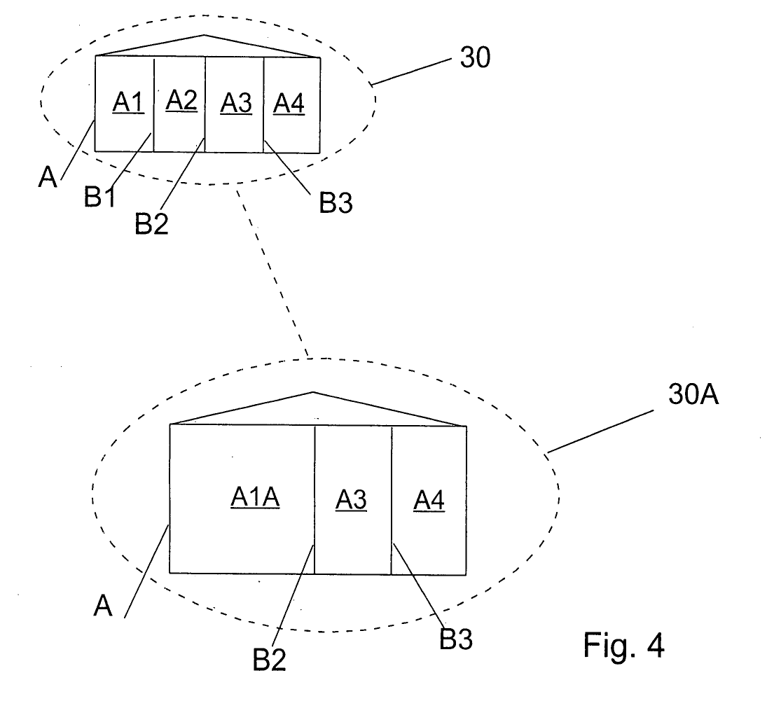

FIG. 3 is an example of a LLC facility with future expansions. LLC initial start-up property 30 consists of one building A having four individual units for lease A1, A2, A3, and A4. All four units are identical in initial construction design and constructed such that partitions B1, B2, B3 between units are movable in order that the square footage of each unit can be increased (or decreased) as will be further shown in FIG. 4. If initial planning with land space is done to allow future expansion, then adding more facilities at a future date can expand the initial LLC. In the example shown, LLC initial start-up property 30 can be expanded to a future LLC facility 31 consisting of adding identical building B which is the same as constructed identically to initial building A. Future expansion is also depicted in 4-building LLC property 32 consisting of four identical buildings A,B,C,D. It should be noted that the initial LLC could deviate from the example shown in that more than one building could be built, depending on the initial amount of investors and/or leaser's. It should also be noted that although LLC initial start-up property 30 is shown by way of example with four internal units, other structural options could be selected, for example six or eight internal units depending on initial LLC requirements.

FIG. 4 is an example of a LLC facility 30 showing further detail of the variable space available within building A. Shown is LLC initial start-up property 30 with four internal units A1, A2, A3, A4. Separation partitions B1, B2, B3 are shown by example to divide LLC initial start-up property 30 into the four internal units. Separation partitions B1, B2, B3 are designed such that they are removable. Separation partitions can be entirely removed or they can be moved to adjust the space of internal units. For example, if the lessee of internal unit A2 of LLC 30 were to move to another facility or give up the lease on unit A2, and if the lessee of internal unit A1 were to need double the present space of internal unit A1, then internal partition B1 could be removed, thereby expanding internal unit A1 to double its floor space A1A as shown in LLC 30A.

The examples in the above FIGS. 3, 4 are shown as but one representation or embodiment of an LLC property. Many other variations or embodiments can be done within the scope of the present invention. It also should be noted that an LLC property, although shown with respect to leased building sites, can consist of many other types of income-producing properties not limited to commercial manufacturing property, industrial property, medical-type facilities, research, development, apartments, housing, agriculture, yachting, power generating facilities, etc.

FIG. 5 is an illustrative drawing of a simple LLC start up showing the first year of cash flow. Initially a LLC promoter plans and builds a building with two divisions at 7.5 k sq. ft. each 501. The LLC promoter puts up $200 k and obtains a bank loan for $800 k at 7% interest 502. SP shares in an amount of $300 k are offered and owned by lessees, lenders, and the promoter and LP shares in the amount of &700 k are offered to lenders in exchange for a lower interest rate (6% assumed) 503. Each tenant (lessee) is offered SP shares based on their respective square footage of lease. Once the offering is complete, the original bank note is paid 504. This example assumes the building is complete at the beginning of the year and a full year rental is collected for the two tenant leases at 15 k sq. ft. total and at $6 per square foot. Block 505 shows income and interest expense. Thus the yearly rental income is $90 k. This example assumes the lessees pay the NNN. A weighted average interest for the first year is assumed at 6.2% (bank loan transferred to participation shares) for a total of $62 k interest. Block 506 illustrates Y.E. net profit and distribution. Net profit is $28 k ($90 k income minus $62 k interest) with 50% going to SP shareholders. The other 50% of the profit is to pay down the LP shares. Depreciation is assumed at $24.5 k, which is also used to pay down the LP share balance. Block 507 shows the LP share pay down of $14 k (50% of profits) plus $24.5 k depreciation for a total of $38.5 k LP share pay down giving a balance of $661.5 k for LP shares. SP shares are never paid down but are rather floated like bonds. SP share ROI is shown in block 508 with 6% interest ($18 k) paid on the $300 k SP shares plus 50% of the profit ($14 k) for a total of $32 k giving a ROI (return on investment) of 10.7%. It should be noted that the rental would increase in subsequent years based on the market value. Also, the LP share interest will remain at 6% so the initial 6.2% weighted average will be replaced by 6% interest. The overall ROI will increase each year based on these factors plus the pay down on the LP shares, which will decrease the yearly interest due on LP shares.

Typical LLC contracts (not shown) could consist of an ‘Operating Agreement’ and ‘Loan Participation Agreement—LLC Members Loan’ and ‘Loan Participation Agreement—LLC Lenders Loan’. The Operating Agreement, for example, would define the operation of the LLC company including, but not limited to, organization, membership, management, capital contributions, membership voting, gross receipts, profits, surplus, losses, capital and draw accounts, distributions, mortgage debt, indemnification, fiscal affairs, transfers or assignment of membership interest, disposition of deceased or incompetent member's interest, redemption of membership interest, dissolution and termination, and other miscellaneous provisions as required. Various types of contracts as stated above are not limited by this invention to this particular embodiment. Other contracts, revisions, amendments etc. may be used without limiting the invention to this particular embodiment.

Beyond real estate, as depicted in the examples above, this patent can apply to corporate organizational methods and schemes. The present invention is a method of conducting business, where the method uses borrowed money, and the business has shareholders wherein the method has:
1. At least one level of notes;
2. At least two levels of notes; and
3. Wherein, at least some of the notes are recorded.

The present invention would also employ at least two of the following features:
a) At one of the levels of notes at least some of the notes are held by lenders of money;
b) At one of the levels of notes at least some of the notes are held by lessees and/or customers;
c) At one of the levels at least some of those notes are held by the promoters, and/or builders;
d) At least some of the money is borrowed in exchange for shares in participation notes;
e) At lease some of the money is borrowed from primary lenders in exchange for shares in LP notes;
f) At lease some of the money is borrowed from primary lenders in exchange for shares in SP notes;
g) At least some of the shares in the SPN notes are subordinated to at least some of the shares in the LPN notes;
h) At least some of the shares in the Participation Notes are subordinated to at least some of the loans on money lent by lenders that do not have an ownership interest in at least some of the shares and/or Participation Note shares;
i) At least some of the shares can be purchased by holders of an option to purchase those shares;
j) At least some of the SPN shares are held by parties that own shares; and
k) A shareholder must own shares in the SPN in a fixed ratio of shares to SPN shares.

The above mentioned notes are subordinate only to loans the lenders of which do not participate in the operation of the business, lenders such as banks, mortgage companies, and finance companies. In one of the aforementioned levels of notes the note holders are also shareholders, and the shareholders lend the money for the notes, wherein the separate notes are held by shareholders and held in the business in a stated ratio of shares of the business to shares of the notes. Some of the shares of the notes can be held only by shareholders of shares in the business in a stated ratio of shares in the business to shares of the notes. Notes are subordinated to notes held by lenders of money, as defined above. Notes are subordinated to loans from lenders as defined above and on at least some of the notes the interest paid is simple interest that is due when paid. Payment of the interest can be delayed for a stated period before the lender is permitted to foreclose on the note. Lenders can hold shares in a LPN. Lenders and/or shareholders lend the money in exchange for shares in a LPN and/pr for shares in a SPN. Interest is paid on the Participation Notes before a payment on the principle of the loan is permitted. At least some of the income from the business is applied to payment of depreciation, principle, and interest in a defined sequence. The defined sequence is defined as;
a) First, the allowance for depreciation is paid to the shareholders;
b) Second, the payment of interest on any loans the lenders of which do not participate in ownership of the business or participates in the operation of the business or participates in ownership of shares an/or shares in Participation Notes;
c) Third, the payment of interest on the LPN;
d) Fourth, the payment of interest on the SPN; and
e) Fifth, the payment of any remainder to the Shareholders as a profit.

In the above first sequence or stage, the income of the business pays the allowance for depreciation and that allowance is paid to the shareholders, and the shareholders immediately lend it to the business in exchange for shares in the SPN, and the SPN immediately applies the money to repayment of the principle on the bank loans and on the LPN. In the second sequence the income pays the interest on any loans to which the LPN and/or the SPN are subordinate. The third and fourth sequence pays the interest on and to the LPN and SPN shares respectively and the fifth sequence of the distribution is paid to the Shareholders as profit. The interest on the SPN is paid to the Shareholders of the SPN. For some period of time the interest is reinvested in the SPN and is applied immediately to pay on the principle of any loans to which the LPN is subordinate, and on the principle of the LPN. Holders of options to purchase shares can only purchase shareholder's shares and buyers of shares must invest in shares of SPN in some stated ratio of share to Shareholder's Participation Note shares. Options are issued also to lenders, promoters and lessees.

Options are distributed such that lenders receive from about 10% to about 90% of the options and lessees receive from about 1% to about 40% of the options and promoters receive from about 40% to about 90% of the options wherein the sum of the options is the same as the number of shares. Promoters would receive those options that are not exercised by the lessees and/or by the lenders. At the time the options are exercised the promoters both lend to and invest in the shares in the SPN.

The purpose of the business or entity is the construction, and/or owning, and/or operating, and/or leasing income-producing property and/or machines and/or equipment wherein the property and/or machines exist as units and have substantially the same design, and/or size, and/or construction. Some examples of units are buildings, and/or portions of buildings, electric generators, wind turbines, electricity-generating solar cells, or substantially similar areas of solar collectors.

Although the present invention has been described with reference to preferred embodiments, numerous modifications and variations can be made and still the result will come within the scope of the invention. No limitation with respect to the specific embodiments disclosed herein is intended or should be inferred.

1. A method of creating a real estate investment instrument, the method comprising the steps of:
a) forming business entity having a promoter;
b) developing under the business entity a multi-tenant commercial real estate property having an initial valuation;
c) offering tenants a lease subject to the tenant's buying shares (participation shares) of the business entity;
d) setting a maximum number of available shareholder participation shares for each tenant based on each tenant's square footage of leased space and a maximum number of shareholder participation shares;
e) offering lenders shares of the business entity called lender participation shares subject to the lender providing a lower than fair market value loan interest rate on a lender loan;
f) setting a value per lender participation share, wherein a sum value of all said shares covers a lender loan amount;
g) setting a maximum number of available lender participation shares based on an amount of the lender loan;
h) collecting rents from each tenant;
i) setting each tenant's rent at an amount which creates a gross profit over and above any costs related to the initial valuation, a real estate loan on the multi-tenant commercial real estate property; and operating expenses, wherein the costs include principal, interest, taxes and insurance (PITI);
j) applying a percent of the gross profits from the rents to all business entity shareholders;
k) applying a balance of the gross profits to pay down the lender loans; and
l) paying a set interest from the business entity's profits to each business entity share, wherein each share is valued at the formation of the business entity.

2. The method of claim 1 further comprising the step of having the promoter borrowing via a builder's loan a percent of the initial valuation, and paying down the builder's loan with the lender participation share monies, the shareholder participation share monies, and the rents.

3. The method of claim 1 further comprising the steps of offering shareholders shares to non-tenants.

4. The method of claim 1 further comprising the step of having the promoter retain business entity share ownership after the sale of all shareholder participation shares and lender participation shares.

5. The method of claim 4, wherein the promoter receives ongoing interest payments based on how many business entity shares the retains.

6. The method of claim 3, wherein the non-tenants include the lenders.

7. The method of claim 1, wherein the percent of the gross profits from the rents paid to all shareholder participation shares is about 50%.

8. The method of claim 1, wherein the set interest is about 6%.

9. The method of claim 7, wherein the set interest is about 6%.

10. The method of claim 1, wherein the business entity is an L.L.C.

11. The method of claim 1 further comprising the step of using a set of plans for the multi-tenant commercial real estate property as a basis for subsequent multi-tenant commercial property within the business entity.

12. The method of claim 1, wherein the step of setting each tenant's rent further comprises periodically raising the tenant rents.

13. The method of claim 1 further comprising the step of allowing a shareholder participation share to be re-sold back to the business entity.

14. The method of claim 1 further comprising the step of setting a percent of original lender loan amount, wherein reaching that percent of pay down results in no longer using the balance of the gross profits to pay down the lender loan, and only paying a lesser amount for an agreed periodic minimum payment for a term of the lender loan.

15. A method to create a business entity for achieving a return on investment (ROI) for shareholders, the method comprising the steps of:
a) forming a business plan having a multi-tenant commercial property as a central asset;
b) creating multiple types of shares of the business entity;
c) said types including a shareholder participation share and a lender participation share;
d) valuing all shares equally based on a valuation of the multi-tenant commercial property so that a total number of available shares equals the valuation;
e) offering lender participation shares only to a lender who provides a loan to the business entity; and
f) offering shareholder participation shares to prospective tenants of the multi-tenant commercial property.

16. The method of claim 15 further comprising executing the business plan, occupying the multi-tenant commercial property with tenants paying a rent.

17. The method of claim 16 further comprising the step of collecting the rents, thereby creating a gross profit arising from the multi-tenant commercial property, and using a percent of the gross profits to pay down the lender loans, and distributing a percent of the gross profits to shareholder participation shareholders.

18. The method of claim 17, wherein an amount of gross profits is used to pay a set interest to all shareholders based on the value of each share.

19. A method of conducting a business, the method comprising the steps of:
a) forming a business entity having a promoter;
b) developing at least one level of participation notes;
c) offering lender participation and shareholder participation note shares;
d) recording at least some of the notes;
e) wherein the method employs at least two of the following elements:
offering at least some of the notes to lenders of money;
offering at least some of the notes to lessees or customers;
providing for at least some of the notes to be held by the promoter, and/or builders;
providing for a portion of the borrowed amount from the lender to be borrowed in exchange for shares in participation notes;
providing for at least some of the money to be borrowed from lenders in exchange for shares in lender participation notes;
providing for at least some of the money to be borrowed from shareholders in exchange for shares in shareholder participation notes;
whereas at least some of the shares in the shareholder participation notes are subordinated to at least some of the shares in the lender participation notes;
whereas at least some of the shares in the participation notes are subordinated to at least some of the loans on money lent by lenders that do not have an ownership interest in at least some of the shares and/or participation note shares;
providing for at least some of the shares to be purchased by holders of an option to purchase those shares;
wherein a shareholder must own shares in the shareholder participation note in a fixed ratio to shareholder participation note shares;
f) wherein notes are subordinate only to loans from lenders who do not participate in the operation of the business;
g) whereas note holders are also shareholders who lend the money for the notes;
h) whereas separate notes held by shareholders are held in a stated ratio of shares of the business to shares of the notes;
i) whereas at least some of the shares of the notes can be held only by shareholders of shares in the business in a stated ratio of shares in the business to shares of the notes;
j) wherein the notes are subordinated to notes held by lenders of money and to loans from lenders;
k) wherein at least on some of the notes the interest payment is simple interest due when paid;
l) said payment can be delayed for a stated period before the lender is permitted to foreclose on the note;
m) providing for lenders to hold shares in a lender's participation note;
n) providing for lenders and/or shareholders to lend the money in exchange for shares in a lenders participation note and/or shares in a participation note;
o) providing for interest to be paid on the participation notes before a payment on the principle is permitted;
p) providing for at lease some of the income from the business to be applied to payment of depreciation, principle, and interest in a defined sequence;
q) applying the defined sequence to be first, the allowance for depreciation paid to the shareholders, second, payment of interest on any loans the lenders of which do not participate in ownership of the business nor participate in the operation of the business nor participates in the ownership of shares or notes, third, payment of interest on and to the lender's participation note, fourth, payment of interest on and to the shareholder's participation note, and fifth, payment of any remainder to the shareholders as a profit;
r) providing for the income of the business to be paid on the allowance for said depreciation that allowance is paid to shareholders and the shareholders immediately lend it to the business in exchange for shares in the shareholder's participation note and the shareholders participation note immediately applies the money to repayment of the principle on the bank loans and on the lenders participation note;
s) providing the income to be paid on interest on any loans to which the lender's participation note and/or the shareholder's participation note are subordinate;
t) providing for some period of time that the interest on the shareholder's participation note is paid to the shareholders of the shareholder's participation note;
u) providing for some period of time that some of the interest is reinvested inn the shareholder's participation note, and that reinvested interest is applied immediately to pay on the principle of any loans to which the lender's participation note is subordinate, and on the principle of the lender's participation note;
v) providing that shareholders shares can be purchased only by holders of options to purchase shares;
w) wherein the buyers of said shares must invest in shares of the shareholder's participation note in some stated ration of share to shareholders participation note shares;
x) providing for options to be issued to lenders, promoters, and lessees;
y) providing for lenders to receive from about 10% to about 90% of said options;
z) providing for lessees to receive from about 1% to about 40% of said options;
aa) providing for promoters to receive from about 40% to about 90% of said options;
bb) providing for the promoters to receive said options that are not exercised by the lessees and/or by the lenders;
cc) providing for the options exercised by the promoters to lend to and invest the shares in the shareholder's participation note;
dd) wherein the business can be the construction, and/or owning, and/or operating, and/or leasing income producing property and/or machines, and/or equipment;
ee) wherein the property and/or machines exist as units, at least two of which have substantially the same design, and/or size and/or construction; and
ff) wherein said units are buildings and/or portions of buildings, and/or electric generators, and/or wind turbines, and/or substantially similar area of electricity-generating solar cells, and/or substantially similar solar collectors;
